(19) United States
(12) Patent Application Publication
(10) Pub. No.: US 2010/0299206 A1
(43) Pub. Date: Nov. 25, 2010

(54) SOFTWARE WITH INTEGRATED ADVERTISING CONTENT

(75) Inventor: Yijin Wang, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/470,488

(22) Filed: May 22, 2009

(51) Int. Cl. G06Q 30/00; G06F 15/177; G06Q 20/00

(52) U.S. Cl. 705/14.55; 709/220

(57) ABSTRACT

Tools and techniques related to software with integrated advertising content are provided. These tools send requests for software, and receive the software in response to these requests. These tools then integrate advertising content into the software, and distribute the software with the integrated advertising content.

### BACKGROUND

With the continuing growth of the software industry worldwide, software piracy remains an ongoing issue for software vendors and developers. Users who wish to utilize software, but are financially unable to pay the license fees associated with the software may face a dilemma: either forego use of the software, or pirate or misappropriate the software and face legal sanctions.

### SUMMARY

Tools and techniques related to software with integrated advertising content are provided. These tools send requests for software, and receive the software in response to these requests. These tools then integrate advertising content into the software, and distribute the software with the integrated advertising content.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments related to software with integrated advertising content.

FIG. 2 is a combined block and flow diagram illustrating examples of value and payment flows related to software with integrated advertising content.

FIG. 3 is a combined block and flow diagram illustrating components and data flows relating to different levels of advertising support provided in connection with the software with integrated advertising content.

FIG. 4 is a block diagram illustrating in more detail components and architectures associated with customer devices.

FIG. 5 is a block diagram illustrating examples of different display scenarios suitable for presenting partially ad-supported software and fully ad-supported software.

FIG. 6 is a block diagram illustrating components and architectures suitable for implementing software vendor systems and advertiser systems.

FIG. 7 is a flow chart illustrating processes for integrating advertising content into pre-existing software.

FIG. 8 is a flow chart illustrating additional processes for integrating advertising content into pre-existing software.

### DETAILED DESCRIPTION

The following detailed description provides tools and techniques for software with integrated advertising content. While the subject matter described herein presents a general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The following detailed description refers to the accompanying drawings that form a part hereof, and that show, by way of illustration, specific example implementations. Referring now to the drawings, in which like numerals represent like elements through the several figures, this description provides various tools and techniques related to software with integrated advertising content.

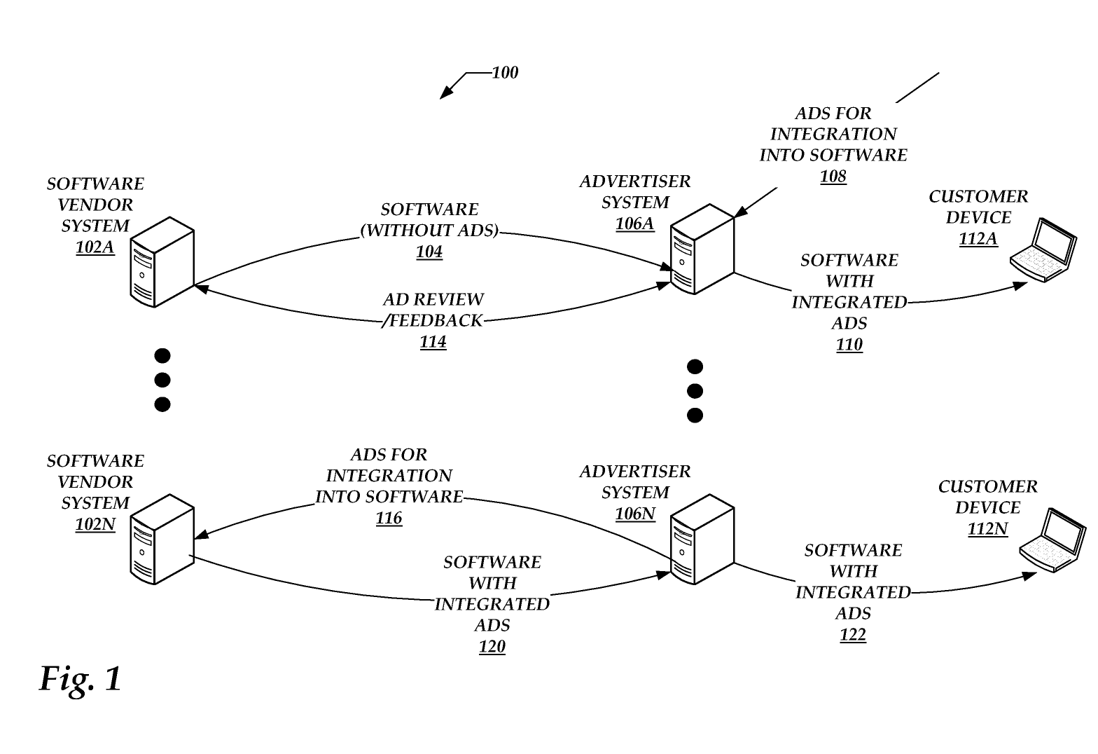

FIG. 1 illustrates systems or operating environments, denoted generally at 100, related to software with integrated advertising content. Turning to FIG. 1 in more detail, these systems 100 may include any number of server systems or servers that are operated by or associated with software vendors. FIG. 1 illustrates examples of such software vendor systems at 102a and 102n (collectively, software vendor systems 102). Although FIG. 1 illustrates two examples of the software vendor systems 102a and 102n, implementations of this description may include any number of software vendor systems 102.

The software vendor systems 102 may operate with several different processes to provide software with integrated advertising content. Turning first to the software vendor system 102a, this system 102a may provide software 104 to another system, with that other system configured to integrate advertising (abbreviated as “ad”) content into the software 104. In general, the software 104 may be provided in a form that enables another system, for example an advertiser system 106a, to integrate the advertising content into the software. However, the software as denoted at 104 does not include the advertising content. For example, the software 104 may represent software in source code form, or in other form suitable for integrating the advertising content. In addition, the software 104 may include operating system software, application software (e.g., software for editing documents, spreadsheets, databases, presentations, and the like), communication software, or any other suitable form of software.

Turning to the advertiser system 106a in more detail, this system 106a may receive the software 104, along with ad content 108. The ad content 108 may or may not originate with the advertiser system 106a, and may relate to any suitable goods or services (collectively, “items”). These items may or may not be provided by the advertiser system 106. In some implementation scenarios, the advertiser system 106 may operate with advertising content 108 relating to items made available by the advertiser system 106. In other implementation scenarios, the advertising content 108 may relate to items provided by third parties, but advertised through the advertiser system 106.

The ad content 108 may pertain to items that are unrelated to the software 104, and the items may be offered by entities other than vendors or developers associated with the software 104. Examples of the ad content 108 may include, but are not limited to, advertisements related to apparel, footwear, food and beverages, goods and services, and the like.

In general, the advertiser system 106a may perform processes that integrate the ad content 108 into the software 104. FIG. 1 provides at 110 examples of the software and the integrated ad content, generated as output by the advertiser system 106a. In turn, the advertiser system 106a may distribute the software 110 for installation on any number of customer devices 112a.

As described in further detail below, the advertiser system 106a may provide a given instance of the software 110 to multiple customer devices 112a. In other scenarios, however, the advertiser system 106a may customize instances of the software 110 for delivery to particular customer devices 112a.

As appreciated from the foregoing description, users of the customer devices 112a may issue appropriate commands to execute the software 110. As described in further detail below, the software 110, when executed, may present the advertising content 108, along with any content typically presented by the software 104 in the absence of the advertising content 108. These users may perceive and visually connect the advertising content 108 with the software 104. Thus, any negative perceptions of the advertising content 108 may reflect also on a developer or publisher of the software 104.

To address or minimize the risk of such negative perceptions, the software vendor system 102a and the advertising system 106a may communicate, as represented generally at 114, to facilitate review and feedback regarding the ad content 108. More specifically, the software vendor system 102a may, for example, preview and analyze the ad content 108. In cases in which analysis indicates that at least some portion of the ad content 108 is objectionable, the communications 114 may include feedback indicating which portions of the ad content 108 are objectionable. In response to this feedback, the advertiser system 106a may modify or substitute for any objectionable ad content, with the indications 114 repeated as appropriate to address objectionable ad content.

FIG. 1 also illustrates scenarios in which the software vendor system 102n may receive ad content 116 from an advertiser system 106n, and integrate the ad content 116 into pre-existing software 118. As discussed above with the software 104, the pre-existing software 118 may represent software in a state suitable for integrating the ad content 116 (e.g., source code, makefile, linkable libraries, and the like). In turn, the software vendor system 102n may produce software 120 as output. The software 120 may represent executable software with the ad content 116 integrated therein. More specifically, the software 120 may present the ad content 116 when a user invokes or executes the software 120, in addition to any software content normally presented by the software 118 when not integrated with the ad content 116.

The software vendor system 102n may transmit the executable software 120 to the advertiser system 106n. For convenience only, FIG. 1 illustrates a scenario in which the advertiser system 106n both sends the ad content 116 and also receives the executable software 120 with integrated ads. However, implementations of this description may also include scenarios in which a given advertiser system 106 provides the ad content 116 and another advertiser system 106 receives the executable software 120 with the ad content 116 integrated therein.

The advertiser system 106n may distribute the executable software, represented at 122, to any number of customer devices 112n. In turn, the software 122 may install onto the customer devices 112n, and execute in response to user commands.

For clarity of illustration only, FIG. 1 illustrates a scenario in which a given instance of the software 122 is distributed to the customer device 112n. However, implementations of this description may also include scenarios in which the given instance of the software 122 is distributed to multiple customer devices 112n. Such implementations may further include scenarios in which different instances of the software 122 are distributed to the customer devices 112n. For example, these different instances of the software 122 may incorporate different advertising content, targeting different users associated with the different customer devices 112n. This targeting may be performed based upon previous behavior associated with such users, based on potential areas of user interest, and the like.

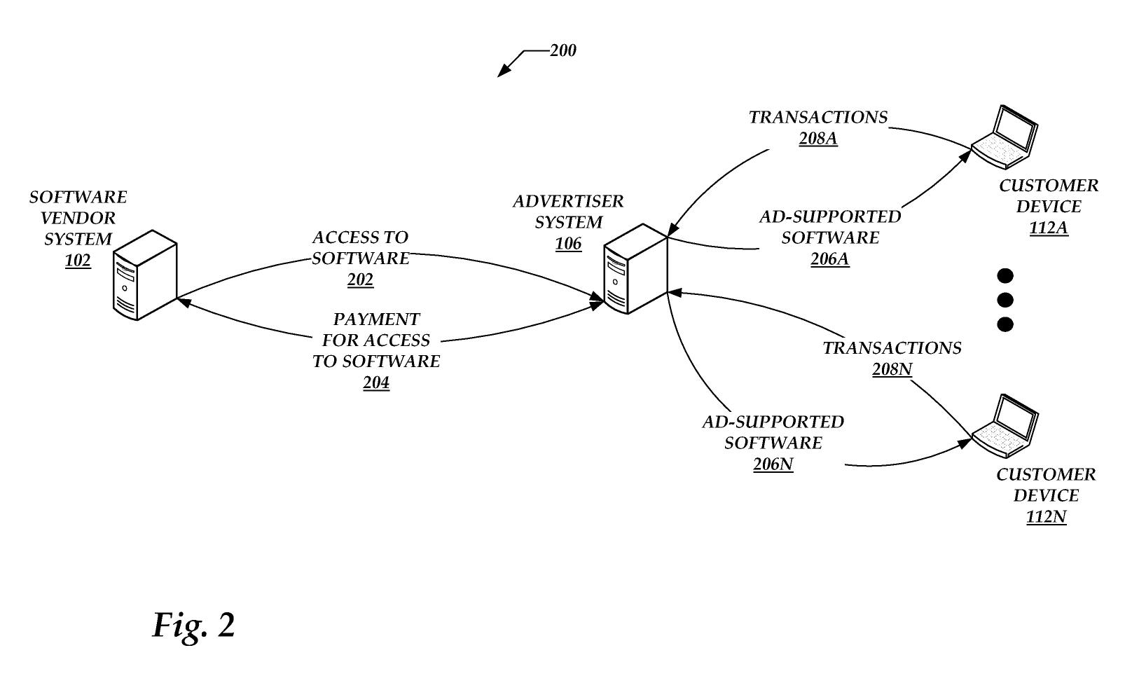

FIG. 2 illustrates examples of value and payment flows, denoted generally at 200, related to software with integrated advertising content. For convenience of description, but not to limit possible implementations, FIG. 2 carries forward certain elements in FIG. 1, as described below in more detail.

Turning to FIG. 2 in more detail, one or more representative software vendor systems 102 may represent any of the software vendor systems 102a and 102n described above in connection with FIG. 1. The software vendor systems 102 may provide one or more representative advertiser systems 106 with access to pre-existing software 202, in exchange for a payment represented generally at 204. The advertiser systems 106 shown in FIG. 2 may represent any of the advertiser systems 106a and 106n shown in FIG. 1. In addition, the pre-existing software 202 may represent the software 104 or 118 as shown in FIG. 1.

Turning to the advertiser systems 106, these systems may operate as described above in FIG. 1 to integrate advertising content into the pre-existing software 202. This advertising content may relate to items of known or possible interest to users associated with one or more customer devices 112a and 112n (as carried forward from FIG. 1). Accordingly, the advertiser systems 106, or other systems acting on behalf of the advertiser systems 106, may provide software 206a and 206n respectively to the customer devices 112a and 112n. License fees associated with the software 206a and 206n (collectively, software 206) may be offset or supported, at least in part, by advertising content integrated into that software 206. Accordingly, this description may refer to the software 206 as ad-supported software 206. In general, the ad-supported software 206 may represent the executable software 110 and/or 122 as shown in FIG. 1.

In exchange for providing the ad-supported software 206 to the customer devices 112, the advertiser systems 106 may anticipate revenues attributable, at least in part, to the ad-supported software 206. More specifically, the advertiser systems 106 may anticipate responses to the advertising content integrated into the ad-supported software 206. In an example scenario, the ad-supported software 206a distributed to the customer device 112a may include advertising content (e.g., 108 or 116 in FIG. 1) relating to footwear offered under a given brand name. When a user accesses the customer device 112a and executes the ad-supported software 206, the ad-supported software 206 may present the advertising content relating to the footwear. If the user is interested in the footwear, that user may respond to the advertising content in some prescribed manner (e.g., clicking on a banner, image, link, or the like, relating to the footwear). In turn, the advertiser system 106 may communicate with the ad-supported software 206 to execute a suitable transaction with the user, regarding the footwear.

From the perspective of users associated with the customer devices 112, the ad-supported software 206 may be provided free of financial charge, in exchange for the users viewing the advertising content integrated into the ad-supported software 206. In other respects, the ad-supported software 206 may be fully operational. In this manner, implementations of this description may offer to these users legal alternatives to pirated or otherwise misappropriated software, by offering fully operational ad-supported software free of direct financial charge.

In general, the advertiser systems 106 may receive indications of any number of transactions 208a and 208n (collectively, transactions 208) originating from the customer devices 112a and 112n. More specifically, these transactions 208 may be attributable, at least in part, to the respective ad-supported software 206a and 206n. For example, these transactions 208 may originate in response to user actions directed to advertisements integrated into the ad-supported software 206.

In implementations of this description, these transactions 208 may take a number of different forms, with illustrative examples of these transactions including consummated sales or leases of items advertised in connection with the ad-supported software 206, inquiries or requests for information related to such items, or the like. These transactions 208 may result in revenue recognized by the advertiser systems 106, or entities operating on behalf of the advertiser systems 106.

To the extent that the transactions 208 result in recognize revenue attributable to distributing the ad-supported software 206, this revenue may be balanced against the payments 204 to define a business model under which the advertiser systems 106 may operate. For example, if the transactions 208 result in revenue that exceeds the payments 204, the advertiser systems 106 may realize a profit. In addition, the software vendor systems 102 may benefit from placing their software on more customer devices 112, in exchange for the payments 204.

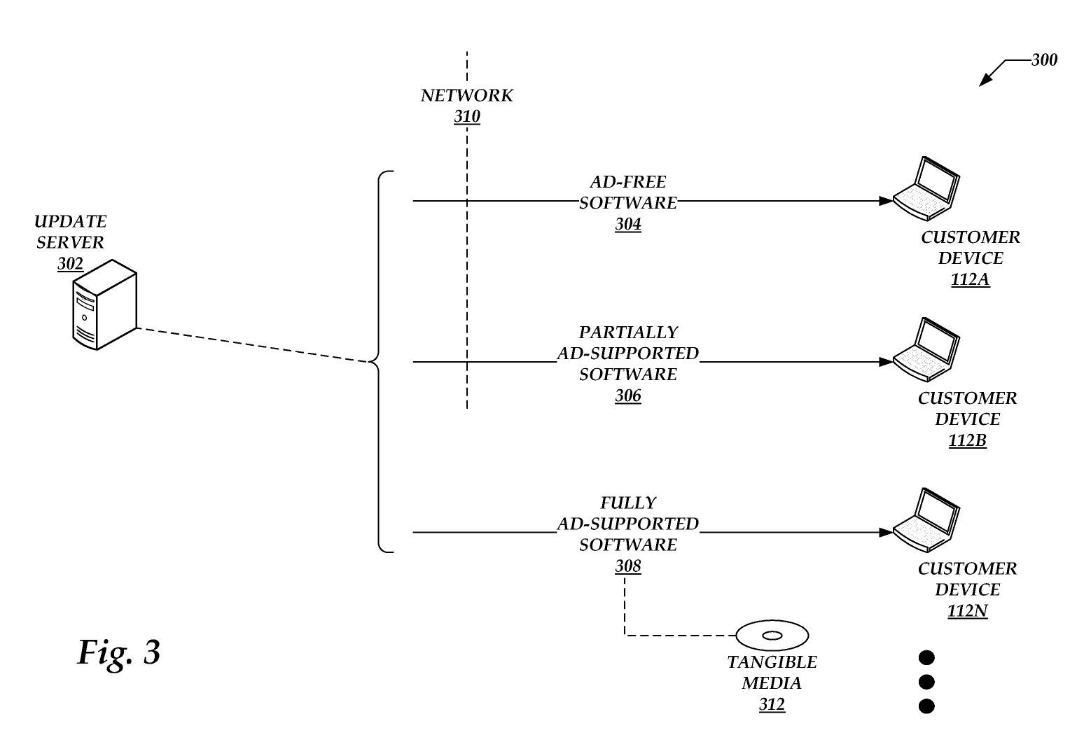

FIG. 3 illustrates components and data flows, denoted generally at 300, relating to different levels of advertising support provided in connection with the software with integrated advertising content. For convenience of description, but not to limit possible implementations, FIG. 3 carries forward certain elements from previous Figures, as described below in more detail.

Turning to FIG. 3 in more detail, any number of update servers 302 may represent any of the software vendor systems 102 or the advertiser systems 106 described in FIGS. 1 and 2. In general, the update servers 302 may operate to distribute software that incorporates varying degrees of advertising support. For example, the update servers 302 may distribute ad-free software 304 to one or more representative customer devices 112a. This ad-free software 304 may have all applicable license fees paid, and thus may not include any advertising content.

The update servers 302 may also distribute software 306 that is supported, at least partially, by advertising content. The software 306 may have at least a portion of the applicable license fees paid, and thus may include some advertising content. As shown in FIG. 3, the update servers 302 may distribute the partially ad-supported software 306 to one or more representative customer devices 112b.

The update servers 302 may also distribute software 308 that is fully supported by advertising content. The software 308 may not have any of the applicable license fees paid, and thus may include more advertising content, as compared to the software 306. As shown in FIG. 3, the update servers 302 may distribute the fully ad-supported software 308 to one or more representative customer devices 112n.

In different possible implementations, the software 306 and/or 308 may include application software (e.g., any of the examples provided above, or others), or may include operating system software. In implementations in which the software 306 and/or 308 includes operating system software, advertising content may be presented using several different techniques. For example, advertising content may be presented within any desktop location on the customer devices 112b or 112c. Advertising content may be integrated into desktop display themes supported by the customer devices 112b or 112c, or may be integrated into cursors or graphics associated with an input device such as a mouse. In addition, operating system software may access system data to further target the advertising content. Examples of such system data may include, but are not limited to: identification of installed software or hardware and related configuration parameters, locations of particular users or devices, and the like.

The software 306 and/or 308 may incorporate one or more advertising modules that present the advertising content in different modes. For example, when a given user is online and connected to a suitable communications network, the software 306 and/or 308 may operate in a live or on-line mode, receiving advertising content dynamically over the network and presenting it on the customer devices 112b and/or 112c using any suitable techniques. In turn, the advertising modules may enable users of the devices 112b and/or 112c to interact with the advertising content. For example, these users may respond to advertising content relating to items of interest.

When the users are off-line, the advertising modules may present advertising content that is built-in and integrated into the software 306 and/or 308. This latter operating mode may be referred to as a static or off-line mode.

Whether operating in on-line or off-line modes, the advertising modules may tailor or target advertising content to particular users based on interests manifested by the users. For example, the advertising modules may gather interest information for particular users based on previous responses to advertising content, website navigation history, online purchase and transactional history.

The advertising modules may also consider targeting information such as the user's location, age, gender, items possessed by the user, and the like. Such information related to particular users may be relayed to advertisers and/or advertiser systems (e.g., 106 in FIG. 1). In addition, the advertisers may determine for particular users which content to integrate into the software 306 and/or 308 to be delivered to these particular users.

As shown in FIG. 3, the update servers 302 may distribute the software 304, 306, or 308 using any number of different delivery mechanisms. For example, FIG. 3 illustrates scenarios in which the software 304 and 306 is delivered over one or more suitable communications networks 310. The networks 310 may generally represent global, wide-area, regional, local-area, or personal networks. In addition, the networks 310 may represent network adapters, connectors, cabling and other hardware infrastructure associated with the foregoing communications networks, as well as any drivers or software associated with communicating through the networks 310.

FIG. 3 also illustrates scenarios in which the fully ad-supported software 308 is delivered to the customer devices 112n on tangible media 312. Examples of the tangible media 312 may include, but are not limited to, CD-ROMs, digital versatile disks (DVDs), flash memory, floppy disks, and the like. In some cases, some of the customer devices (e.g., 112n) may not have access to the communications networks 310. Accordingly, any of the software 304, 306, and 308 may be delivered via tangible media 312 to any customer devices 112n that do not have access to the communications networks 310.

In illustrating the various scenarios shown in FIG. 3, it is noted that implementations of this description may support other scenarios, without departing from the scope and spirit of this description. For example, any of the software 304, 306, or 308 may be delivered to the customer devices 112 over the communications networks 310, or may be delivered to the customer devices 112 via tangible media 312, depending on the capabilities and connectivity of the customer devices 112.

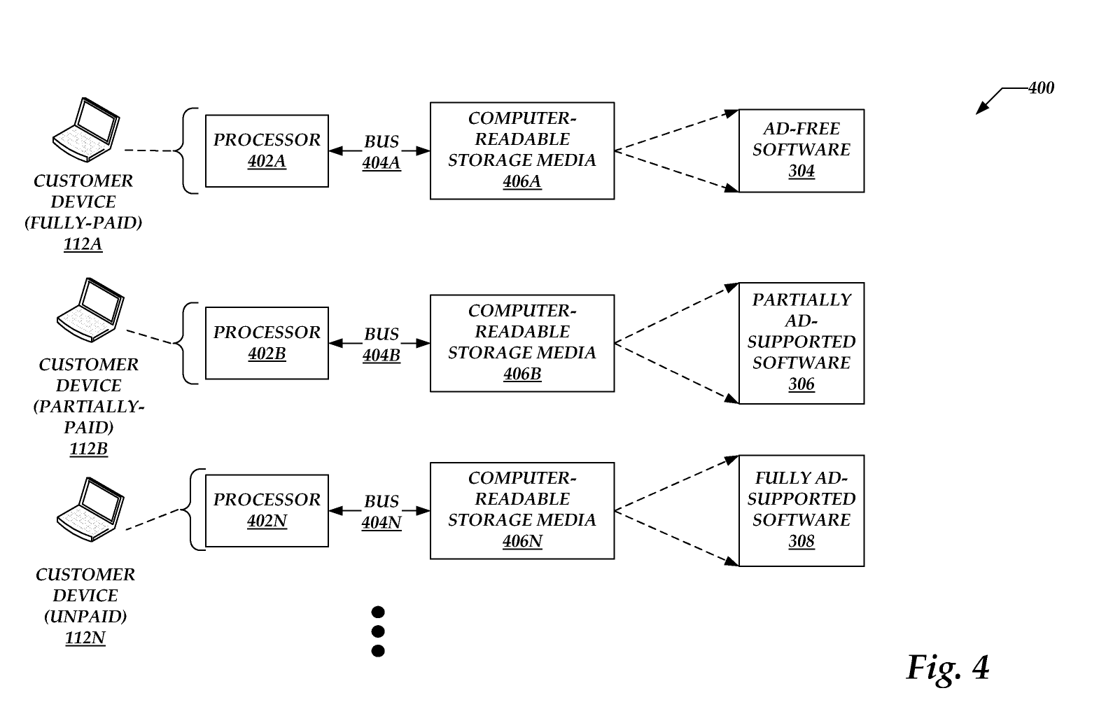

FIG. 4 illustrates in more detail components and architectures, denoted generally at 400, associated with the customer devices. For convenience of description, but not to limit possible implementations, FIG. 4 carries forward certain elements from previous Figures, as described below in more detail. More specifically, FIG. 4 illustrates examples of three customer devices 112a, 112b, and 112n (collectively, customer devices 112). In general, the following description applies equally to the three customer devices 112, unless explicitly noted to the contrary.

Turning to the customer devices 112 in more detail, these devices may include one or more instances of processing hardware, with FIG. 4 providing respective processors 402a, 402b, and 402n (collectively, assessors 402) as examples of such processing hardware. The processors 402 may have a particular type or architecture, chosen as appropriate for particular implementations. In addition, the processors 402 may couple to one or more respective bus systems 404a, 404b, and 404n (collectively, bus systems 404), having type and/or architecture that is chosen for compatibility with the processors 402.

The customer devices 112 may include one or more instances of a physical computer-readable storage medium or media 406a, 406b, and 406n (collectively, storage medium or media 406), which couple to the bus systems 404. The bus systems 404 may enable the processors 402 to read code and/or data to/from the computer-readable storage media 406. The media or 06 may represent apparatus in the form of storage elements that are implemented using any suitable technology, including but not limited to semiconductors, magnetic materials, optics, or the like. The media 406 may represent memory components, whether characterized as RAM, ROM, flash, solid-state hard drive, or other types of technology.

The storage media 406 may include one or more modules of software instructions that, when loaded into the processors 402 and executed, cause the customer devices 112 to execute the software with integrated advertising content. As detailed throughout this description, these modules of instructions may also provide various tools or techniques by which the customer devices 112 may participate within the overall systems or operating environments described herein using the components, message and command flows, and data structures discussed in more detail throughout this description. For example, the storage media 406a-406n may respectively contain one or more modules of software 304-308, described above in connection with FIG. 3.

In general, the modules 304-308 for software with integrated advertising content may, when loaded into the processors 402 and executed, transform the processors 402 and the overall customer devices 112 from general-purpose computing systems into special-purpose computing systems customized to present integrated advertising content. The processors 402 may be constructed from any number of transistors or other discrete circuit elements, which may individually or collectively assume any number of states. More specifically, the processors 402 may operate as finite-state machines, in response to executable instructions contained within the software 304-308. These computer-executable instructions may transform the processors 402 by specifying how the processors 402 transition between states, thereby physically transforming the transistors or other discrete hardware elements constituting the processors 402.

Encoding the software modules 304-308 with integrated advertising content may also transform the physical structure of the storage media 406. The specific transformation of physical structure may depend on various factors, in different implementations of this description. Examples of such factors may include, but are not limited to: the technology used to implement the storage media 406, whether the storage media 406 are characterized as primary or secondary storage, and the like. For example, if the storage media 606 is implemented as semiconductor-based memory, the software modules 304-308 may transform the physical state of the semiconductor memory, when the software is encoded therein. For example, the software may transform the states of transistors, capacitors, or other discrete circuit elements constituting the semiconductor memory.

As another example, the storage media 406 may be implemented using magnetic or optical technology. In such implementations, the software 304-308 with integrated advertising content may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In the examples shown in FIG. 4, the customer device 112a may have all license fees applicable to the software 304 paid. Accordingly, the software 304 may be ad-free, since the license fees have been paid. The customer device 112b may have at least some license fees applicable to the software 306 paid. Accordingly, the software 304 may be at least partially ad-supported software, since at least some of the license fees have been paid. Finally, the customer device 112n may not have any of the license fees applicable to the software 308 paid. Accordingly, the software 308 may be fully ad-supported software, since none of the license fees have been paid.

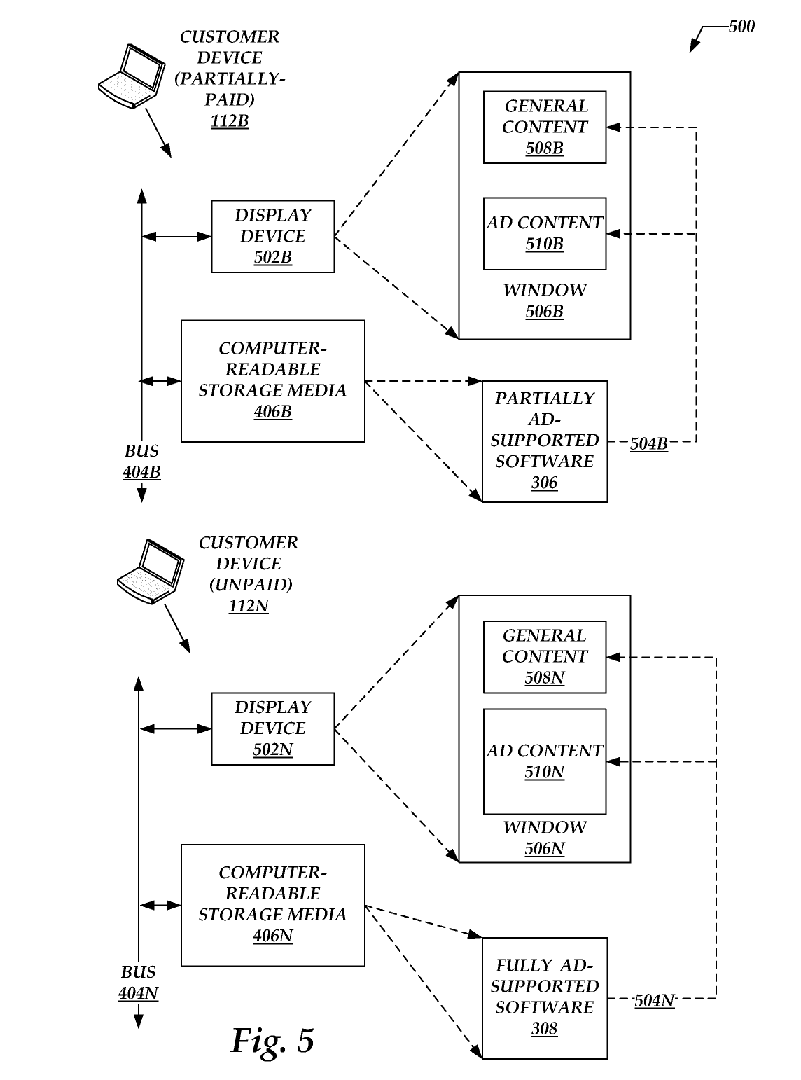

FIG. 5 illustrates different display scenarios, denoted generally at 500, suitable for presenting partially ad-supported software and fully ad-supported software. For convenience of description, but not to limit possible implementations, FIG. 5 carries forward certain elements described in previous drawings Figures, as described below in more detail.

Turning to FIG. 5 in more detail, a representative customer device, carried forward at 112b, may include a bus system 404b and storage media 406b. The storage media 406b may contain at least the partially ad-supported software 306, carried forward from FIG. 3. The customer devices 112 may also include one or more instances of display hardware or display devices 502b, coupled to communicate with the bus systems 404b.

In more detail, the display devices 502b may take different forms, depending on the capabilities of different particular customer devices 112b. The display devices 502b may be constructed with any suitable technology, recognized as appropriate in different implementation scenarios. In general, the display devices 502b may present data or information in visible form to any number of human users associated with the overall customer devices 112b.

When executed, the partially ad-supported software 306 may present content on the display devices 502b, by sending appropriate signals over the bus systems 404b. FIG. 5 generally represents these signals by dashed lines 504b. More specifically, the software 306 may cause the display device 502b to present a display window 506b. In turn, the software 306 may present certain content within the display window 506b. This content may include general content 508b and ad content 510b.

Turning to the general content 508b in more detail, this content 508b may represent content that the software 306 would present to a user, if it did not include the integrated ad content. The general content 508b may correspond to content associated with the pre-existing software 104 and 118, as shown in FIG. 1. For example, if the software 306 is a word processing application, the general content 508b may represent any menus and user interface elements associated with the word processing application, excluding the integrated ad content.

Turning to the ad content 510b in more detail, this content 510b may represent the ad content referenced in FIG. 1 at 108 and 116. As described previously, this ad content may be integrated into the partially ad-supported software 306.

A representative customer device, carried forward at 112n, may include a bus system 404n and storage media 406n, with the storage medium 406n containing at least the fully ad-supported software 308, carried forward from FIG. 3. The customer device 112n may also include a suitable display device 502n, with the above description of the display device 502b applying generally to the display device 502n.

When executed, the fully ad-supported software 308 may present content on the display devices 502n, by sending appropriate signals over the bus systems 404n. FIG. 5 generally represents these signals by dashed lines 504n. More specifically, the software 308 may cause the display device 502n to present a display window 506n. In turn, the software 308 may present certain content within the display window 506n. This content may include general content 508n and ad content 510n.

In general, the foregoing description of the general content 508b applies equally to the general content 508n, and the foregoing description of the ad content 510b applies equally to the ad content 510n. However, the fully ad-supported software 308 may present the ad content 510n more prominently in the display window 506n, as compared to the ad content 510b as presented in the display window 506b. For example, although FIG. 5 is not drawn to scale, FIG. 5 illustrates scenarios in which the portion of the display window 506n allocated to displaying the ad content 510n is larger, relative to the portion of the display window 506b allocated to displaying the ad content 510b. As another example, the ad content 510n may be displayed for a longer duration within the window 506n, relative to the amount of time that the ad content 510n is displayed within the window 506b.

In general, although the ad content 510n may be displayed more frequently or more prominently, relative to the ad content 510b, the ad content 510n may be displayed so that it does not unduly interfere with visual perception of the general content 508n, or with general operation of the software 308. Recalling previous description of FIG. 1, the review and feedback processes denoted at 114 may include considering the visual or perceptive impact of the ad content relative to the pre-existing software. More specifically, the software vendor systems 102 may analyze whether proposed ad content would interfere visually or functionally with operation of the pre-existing software provided by or through the software vendor systems 102.

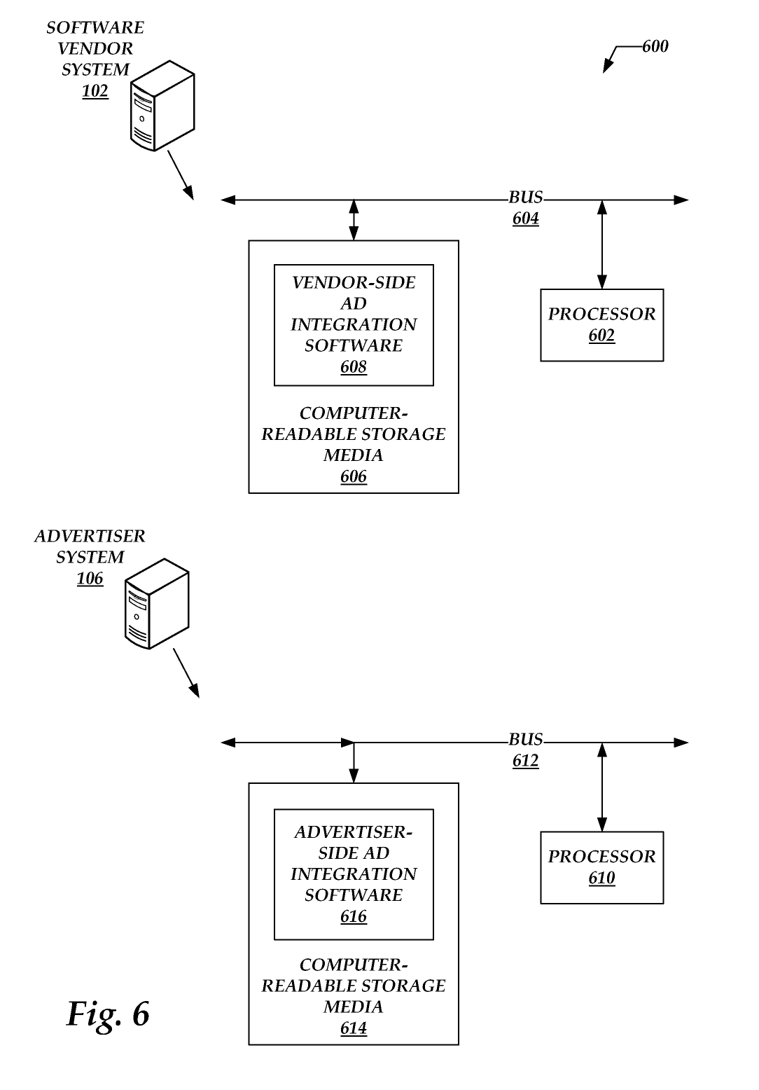

FIG. 6 illustrates components and architectures, denoted generally at 600, suitable for implementing the software vendor systems 102 and the advertiser systems 106. Turning first to the software vendor system 102, these systems may include one or more instances of processing hardware, with FIG. 6 providing processor 602 as examples of such processing hardware. The processors 602 may have a particular type or architecture, chosen as appropriate for particular implementations. It is noted that the type and architecture of the processors 602 may or may not be the same as that of the processors 402 shown in FIG. 4.

The processors 602 may couple to one or more bus systems 604, having type and/or architecture that is chosen for compatibility with the processors 602. However, the type and architecture of the bus systems 604 may or may not be the same as that of the bus systems 404 shown in FIG. 4.

The systems 102 may include one or more instances of a physical computer-readable storage medium or media 606, which couple to the bus systems 604. The bus systems 604 may enable the processors 602 to read code and/or data to/from the computer-readable storage media 606. The media 606 may represent apparatus in the form of storage elements that are implemented using any suitable technology, including but not limited to semiconductors, magnetic materials, optics, or the like. The media 606 may represent memory components, whether characterized as RAM, ROM, flash, solid-state hard drive, or other types of technology.

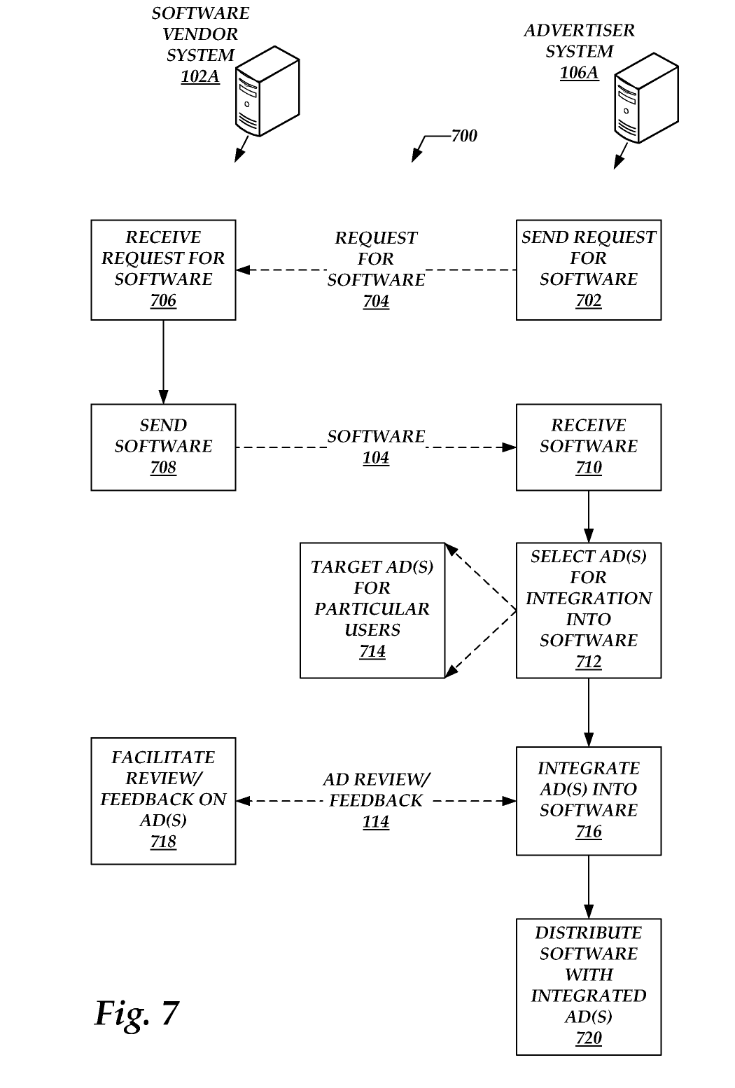

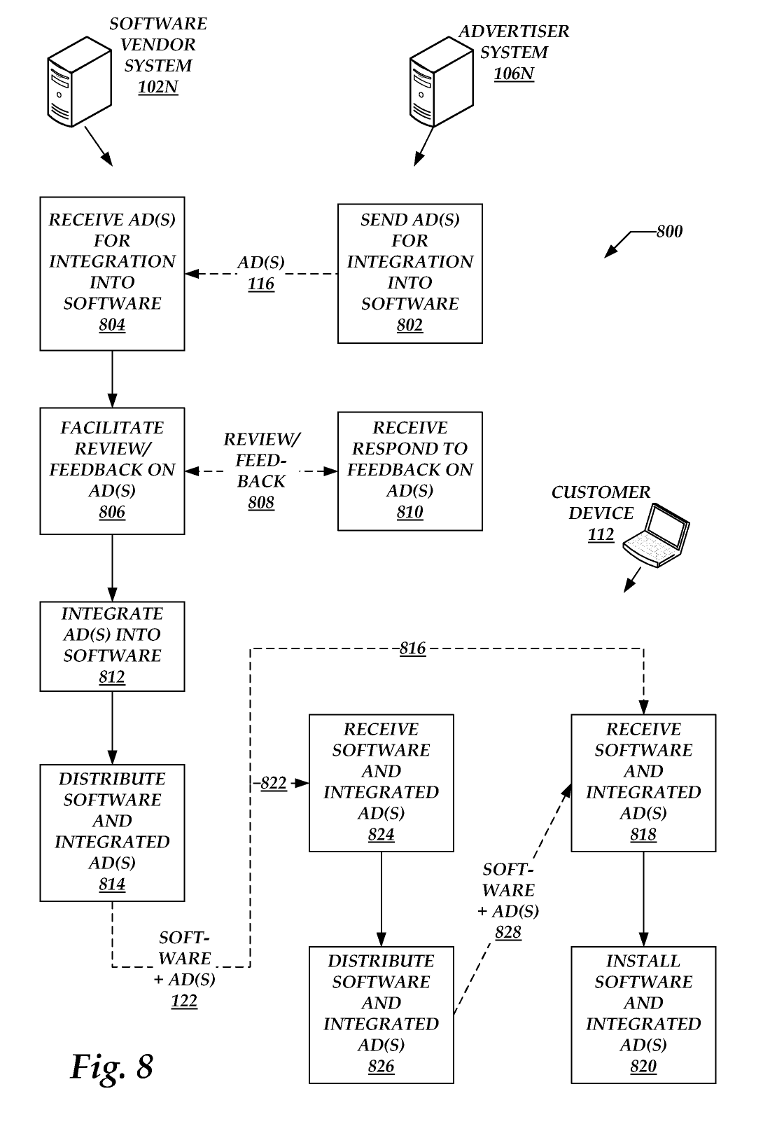

The storage media 606 may include one or more modules of software instructions that, when loaded into the processors 602 and executed, cause the systems 102 to participate in creating the software with integrated advertising content. As detailed throughout this description, these modules of instructions may also provide various tools or techniques by which the systems 102 may participate within the overall systems or operating environments described herein using the components, message and command flows, and data structures discussed in more detail throughout this description. For example, the storage media 606 may contain one or more modules of vendor-side ad integration software 608. The software 608 may be configured to perform any of the vendor-side functions illustrated in FIGS. 1-2, and are detailed further in the flowcharts shown in FIGS. 7 and 8.

In general, the software 608 may, when loaded into the processors 602 and executed, transform the processors 602 and the overall systems 102 from general-purpose computing systems into special-purpose computing systems customized to present integrated advertising content. The processors 602 may be constructed from any number of transistors or other discrete circuit elements, which may individually or collectively assume any number of states. More specifically, the processors 602 may operate as finite-state machines, in response to executable instructions contained within the software 608. These computer-executable instructions may transform the processors 602 by specifying how the processors 602 transition between states, thereby physically transforming the transistors or other discrete hardware elements constituting the processors 602.

Encoding the software 608 may also transform the physical structure of the storage media 606. The specific transformation of physical structure may depend on various factors, in different implementations of this description. Examples of such factors may include, but are not limited to: the technology used to implement the storage media 606, whether the storage media 606 are characterized as primary or secondary storage, and the like. For example, if the storage media 606 are implemented as semiconductor-based memory, the software 608 may transform the physical state of the semiconductor memory, when the software is encoded therein. For example, the software may transform the states of transistors, capacitors, or other discrete circuit elements constituting the semiconductor memory.

As another example, the storage media 606 may be implemented using magnetic or optical technology. In such implementations, the software 608 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Turning to the advertiser systems 106 in more detail, these systems may include one or more instances of processing hardware, with FIG. 6 providing processors 610 as examples of such processing hardware. The processors 610 may have a particular type or architecture, chosen as appropriate for particular implementations. In addition, the processors 610 may couple to one or more bus systems 612, having type and/or architecture that is chosen for compatibility with the processors 610. However, the type and architecture of the processors 610 and bus systems 612 may or may not be the same as that chosen for the processors 602 and bus systems 604.

The advertiser systems 106 may include one or more instances of a physical computer-readable storage medium or media 614, which couple to the bus systems 612. The bus systems 612 may enable the processors 610 to read code and/or data to/from the computer-readable storage media 614. The media 614 may represent apparatus in the form of storage elements that are implemented using any suitable technology, including but not limited to semiconductors, magnetic materials, optics, or the like. The media 614 may represent memory components, whether characterized as RAM, ROM, flash, solid-state hard drive, or other types of technology.

The storage media 614 may include one or more modules of software instructions that, when loaded into the processors 610 and executed, cause the advertiser systems 106 to participate in creating the software with integrated advertising content. As detailed throughout this description, these modules of instructions may also provide various tools or techniques by which the advertiser systems 106 may participate within the overall systems or operating environments described herein using the components, message and command flows, and data structures discussed in more detail throughout this description. For example, the storage media 614 may contain one or more modules of advertiser-side ad integration software 616. The software 616 may be configured to perform any of the advertiser-side functions illustrated in FIGS. 1-2, and is detailed further in the flowcharts shown in FIGS. 7 and 8.

In general, the software 616 may, when loaded into the processors 610 and executed, transform the processors 610 and the overall advertiser systems 106 from general-purpose computing systems into special-purpose computing systems customized to present integrated advertising content. The processors 610 may be constructed from any number of transistors or other discrete circuit elements, which may individually or collectively assume any number of states. More specifically, the processors 610 may operate as finite-state machines, in response to executable instructions contained within the software 616. These computer-executable instructions may transform the processors 610 by specifying how the processors 610 transition between states, thereby physically transforming the transistors or other discrete hardware elements constituting the processors 610.

Encoding the software 616 may also transform the physical structure of the storage media 614. The specific transformation of physical structure may depend on various factors, in different implementations of this description. Examples of such factors may include, but are not limited to: the technology used to implement the storage media 614, whether the storage media 614 are characterized as primary or secondary storage, and the like. For example, if the storage media 614 are implemented as semiconductor-based memory, the software 616 may transform the physical state of the semiconductor memory, when the software is encoded therein. For example, the software 616 may transform the states of transistors, capacitors, or other discrete circuit elements constituting the semiconductor memory.

As another example, the storage media 614 may be implemented using magnetic or optical technology. In such implementations, the software 616 may transform the physical state of magnetic or optical media, when the software 616 is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

FIG. 7 illustrates process flows, denoted generally at 700, suitable for integrating advertising content into pre-existing software. For convenience of description, but not to limit possible implementations of this description, the process flows 700 are described in connection with the software vendor system 102a and the advertiser system 106a, both of which are carried forward from FIG. 1. However, implementations of this description may perform at least portions of the process flows 700 in connection with other components and computing systems, without departing from the scope and spirit of the present description.

Turning to the process flows 700 in more detail, block 702 represents sending a request for software, into which advertising content is to be integrated. The requested software may be characterized as pre-existing, in the sense that the software has already been developed at the time of the request. In the examples shown in FIG. 7, the advertiser system 106a may perform block 702. FIG. 7 also denotes the request for the software at 704.

Block 706 represents receiving the request 704 for the software. In turn, block 708 represents sending at least one instance of the software in response to the request 704. FIG. 7 carries forward an example of the software at 104, as provided by the software vendor system 102a to the advertiser system 106a.

Block 710 represents receiving the requested software 106. In the examples shown in FIG. 7, the advertiser system 106a may perform block 710, receiving the requested software 104 from the software vendor system 102a.

Block 712 represents selecting advertising content to be integrated into the software 104 received in block 710. FIG. 1 provides examples of such advertising content at 108. In some implementations, block 712 may include selecting and targeting the advertising content to particular users, as represented generally by block 714. This selection and targeting process may involve considering previous behavior exhibited by the targeted users, areas of known or potential interest associated with those users, and/or other similar factors.

Block 716 represents integrating the ad content into the software received in block 710. Block 716 may include combining the ad content into the software, to generate a single executable image. In this manner, end users may not readily remove the ad content as integrated into the software.

In some implementations, block 716 may include facilitating a review and feedback cycle with, per example, the software vendor system 102a. FIG. 7 carries forward at 114 an example of ad review and feedback, as performed between the advertiser system 106a and the software vendor system 102a.

At the software vendor system 102a, block 718 represents facilitating review and/or feedback on ad content. For example, block 718 may include analyzing whether proposed ad content involves subject matter considered inappropriate for association and integration with the software 104. Block 718 may also include analyzing whether presentation of the ad content may interfere unduly with visual perception or operation of the software 104. Block 718 may include considering other factors as well, with the foregoing examples provided only as illustration.

Block 720 represents distributing the software, as integrated with the ad content from block 716. FIG. 1 provides examples of such software at 110. Block 720 may include distributing the software to any number of customer devices 112.

FIG. 8 illustrates additional process flows, denoted generally at 800, suitable for integrating advertising content into pre-existing software. For convenience of description, but not to limit possible implementations of this description, the process flows 800 are described in connection with the software vendor system 102n and the advertiser system 106n, both of which are carried forward from FIG. 1. However, implementations of this description may perform at least portions of the process flows 800 in connection with other components and computing systems, without departing from the scope and spirit of the present description.

Turning to the process flows 800 in more detail, block 802 represents sending one or more instances of ad content for integration into software. For convenience only, FIG. 8 carries forward an example of ad content at 116, as sent by the advertiser system 106n to the software vendor system 102n.

Block 804 represents receiving the ads 116 for integration into software. More specifically, block 804 may include receiving ads for integration into pre-existing software made available by or through the software vendor system 102n.

Block 806 represents facilitating review and/or feedback on the ad content received in block 804. As denoted at 808, the software vendor system 102n and the advertiser system 106n may exchange review and/or feedback information regarding particular ad content. The advertiser system 106n may perform block 810 to receive feedback provided on particular ads, and to respond to that feedback to address any objectionable features of the particular ads.

Block 812 represents integrating the ad content into the software. In some implementation scenarios, block 812 may include integrating the ad content as received in block 804 into the software. In other implementation scenarios, block 812 may include integrating the ad content as revised in response to the review and/or feedback 808.

Block 814 represents distributing the software and integrated ad content. For convenience of description, FIG. 8 carries forward from FIG. 1 example software and integrated ad content 122. In some implementation scenarios, block 814 may include distributing the software and integrated ad content 122 directly to a number of customer devices (e.g., 112), as represented generally at 816. In these scenarios, block 818 represents receiving the software and integrated ad content at the customer device 112. In turn, block 820 represents installing the software and integrated ads on the customer device 112.

In other implementation scenarios, block 814 may include distributing the software and integrated ad content 122 to any number of advertiser systems 106n, as represented at 822. In these latter scenarios, block 824 represents receiving the software and integrated ads at any number of the advertiser systems 106n. In turn, block 826 represents distributing the software and integrated ads from the advertiser systems 106n to any number of the customer devices 112. FIG. 8 represents at 828 the software and integrated ads, as distributed from the advertiser systems 106n.

The foregoing description provides software with integrated advertising content. Although this description incorporates language specific to computer structural features, methodological acts, and computer readable media, the scope of the appended claims is not necessarily limited to the specific features, acts, or media described herein. Rather, this description provides illustrative, rather than limiting, implementations. Moreover, these implementations may modify and change various aspects of this description without departing from the true spirit and scope of this description, which is set forth in the following claims.

We claim:

1. Apparatus comprising at least one physical computer-readable storage medium having stored thereon computer-executable instructions that, when loaded into at least one hardware processor and executed, transform the hardware processor to perform the following:
send at least one request for software;
receive the software in response to the request;
integrate at least one instance of advertising content into the software; and
distribute the software with integrated advertising content.

2. The apparatus of claim 1, further comprising instructions that transform the hardware processor to select the advertising content for integration into operating system software.

3. The apparatus of claim 1, further comprising instructions that transform the hardware processor to select the advertising content for integration into the software based upon characteristics associated with particular users of customer devices.

4. The apparatus of claim 1, further comprising instructions that transform the hardware processor to target particular users of customer devices in selecting the advertising content for integration into the software.

5. The apparatus of claim 1, further comprising instructions that transform the hardware processor to facilitate review and feedback on the advertising content.

6. The apparatus of claim 5, further comprising instructions that transform the hardware processor to revise the advertising content in response to the review and feedback.

7. The apparatus of claim 1, wherein the instructions that transform the hardware processor to integrate at least one instance of advertising content into the software include instructions that transform the hardware processor to generate an executable image of the software that incorporates the advertising content.

8. The apparatus of claim 1, wherein the instructions that transform the hardware processor to distribute the software include instructions that transform the hardware processor to distribute different advertising content, integrated into the software, to different customer devices.

9. Apparatus comprising at least one physical computer-readable storage medium having stored thereon computer-executable instructions that, when loaded into at least one hardware processor and executed, transform the hardware processor to perform the following:
send at least one instance of advertising content for integration into at least one instance of software;
receive the software with the advertising content integrated therein; and
distribute the software for installation on at least one customer device.

10. The apparatus of claim 9, further comprising instructions that transform the hardware processor to facilitate review and feedback on the advertising content.

11. The apparatus of claim 10, further comprising instructions that transform the hardware processor to revise the advertising content in response to the review and feedback.

12. The apparatus of claim 9, further comprising instructions that transform the hardware processor to select the advertising content to be sent for integration into the software.

13. The apparatus of claim 9, further comprising instructions that transform the hardware processor to select the advertising content to be sent for integration into the software based upon characteristics associated with particular users of customer devices.

14. The apparatus of claim 9, further comprising instructions that transform the hardware processor to target particular users of customer devices in selecting the advertising content to be sent for integration into the software.

15. A system comprising:
at least one software vendor system configured to operate in a first mode to provide software to have advertising content integrated therein, and configured to operate in a least a further mode to receive further advertising content and to integrate the further advertising content into further software;
at least one advertiser system configured to cooperate with the software vendor system operating in the first mode to receive the software and to integrate the advertising content into the software, and configured to cooperate with the software vendor system operating in the further mode to receive the further software; and
at least one customer device configured to receive the further software from the software vendor system or the advertiser system.

16. The system of claim 15, wherein the software or the further software is associated with license fees that are at least partially offset by the advertising content, and wherein the customer device is configured to execute the software or the further software and to present the advertising content to a user of the customer device.

17. The system of claim 16, wherein the customer device is configured to present the advertising content less prominently, as compared to presentation of advertising content that fully offsets the license fees.

18. The system of claim 15, wherein the software or the further software is associated with license fees that are fully offset by the advertising content, and wherein the customer device is configured to execute the software or the further software and to present the advertising content to a user of the customer device.

19. The system of claim 18, wherein the customer device is configured to present the advertising content more prominently prominently, as compared to presentation of advertising content that partially offsets the license fees.

20. The system of claim 15, wherein the software vendor system is configured to receive a payment in exchange for providing the software to have the advertising content integrated therein.
